(19) United States
(12) Patent Application Publication
(10) Pub. No.: US 2023/0087849 A1
(43) Pub. Date: Mar. 23, 2023

(54) USING THREAT OF POWER INTERRUPTION TO IMPROVE PREPAREDNESS OF BACKUP POWER SOURCE

(71) Applicant: Lenovo (United States) Inc., Morrisville, NC (US)

(72) Inventors: Jeremy Robert Carlson, Raleigh, NC (US); Philip John Jakes, Durham, NC (US); Charles C. Queen, Apex, NC (US)

(21) Appl. No.: 17/478,460

(22) Filed: Sep. 17, 2021

(51) Int. Cl. G06F 1/30; G06F 1/26; G06F 1/28

(52) U.S. Cl. CPC G06F 1/305; G06F 1/263; G06F 1/28

(57) ABSTRACT

The preparedness of a backup power supply is enhanced by receiving data from a source external to the backup power supply. It is determined from the data that there is a threat of power interruption. The charge on the backup power supply is varied based on the threat of power interruption.

### TECHNICAL FIELD

Embodiments described herein generally relate to backup power sources, and in an embodiment, but not by way of limitation, improving the preparedness of backup power sources based on a threat of power interruption.

### BACKGROUND

Existing battery backup units (BBU) or uninterruptable power supplies (UPS) operate unaware of their external environment. Even a “Smart UPS” is focused on internal sensing and monitoring, not on anything external to it.

Certain BBUs, such as Li-ion BBUs, limit the charge in the BBU to 70-80% of maximum capacity to preserve the longevity of the BBU. This limitation leads to diminished backup capacity than would be possible if the BBU was charged to 100%. Also, for optimal battery health and lifespan, the BBU needs to be fully cycled, that is fully discharged, on a regular basis. This is usually handled by setting a regular schedule of when it is most likely to be convenient to fully drain and then recharge the BBU. Both these conditions mean that less than full energy of the battery pack may be available at the time of an outage, even if the risk of an outage may be higher than normal due to some external event, such as impending severe weather.

### BRIEF DESCRIPTION OF THE DRAWINGS

In the drawings, which are not necessarily drawn to scale, like numerals may describe similar components in different views. Like numerals having different letter suffixes may represent different instances of similar components. Some embodiments are illustrated by way of example, and not limitation, in the figures of the accompanying drawings.

FIGS. 1A and 1B illustrate a process to improve the preparedness of backup power sources based on a threat of power interruption.

FIG. 2 is a block diagram of a computer architecture upon which one or more of embodiments disclosed herein can execute.

### DETAILED DESCRIPTION

In an embodiment, various sources of data such as sensors, external data sources, and connected devices can be used to dynamically vary the overall charge level on a battery backup unit (BBU) or an uninterruptible power supply (UPS) based on a likelihood of power failure. If the likelihood of power loss is increased, if the availability of the load is critical, and/or if the nature of the load is unusual in some manner, the charge level of the BBU and/or UPS can be increased, thereby providing a longer runtime of the load using the power provided by the BBU and/or the UPS. When the likelihood of power failure returns to a particular baseline, the charge level of the BBU and/or UPS can be returned to its normal level by powering the load from the BBU and/or the UPS for a short period of time. In this manner, knowledge of the external situation can be used to ensure that the BBU and/or UPS has the greatest possible energy at the times when it is most likely to be needed.

Similarly, this information could also be used to ensure that the risk of an outage is not above a specific threshold before starting a maintenance cycle that includes discharging the BBU and/or UPS. Furthermore, continued monitoring of the external data could be used to ensure the risk level stays below the threshold during maintenance cycling, or else the maintenance is aborted.

There are a variety of data sources that can be used in connection with the disclosed embodiments. For example, an Internet weather service could warn that severe weather is approaching an area. A temperature could be received from a temperature sensor, and the BBU and/or the UPS could be charged or discharged based on the temperature. It is noted that battery longevity is harmed less if battery cell temperature is below 40 degrees Celsius. Therefore, the risk is lower to proactively charge the BBU and/or the UPS if the current temperature range is safe. Other sensors can also be used such as microphones to pick up thunder and/or severe wind, cameras to capture pictures of impending severe weather, and/or light sensors to sense darkening conditions and an impending storm during the daylight hours.

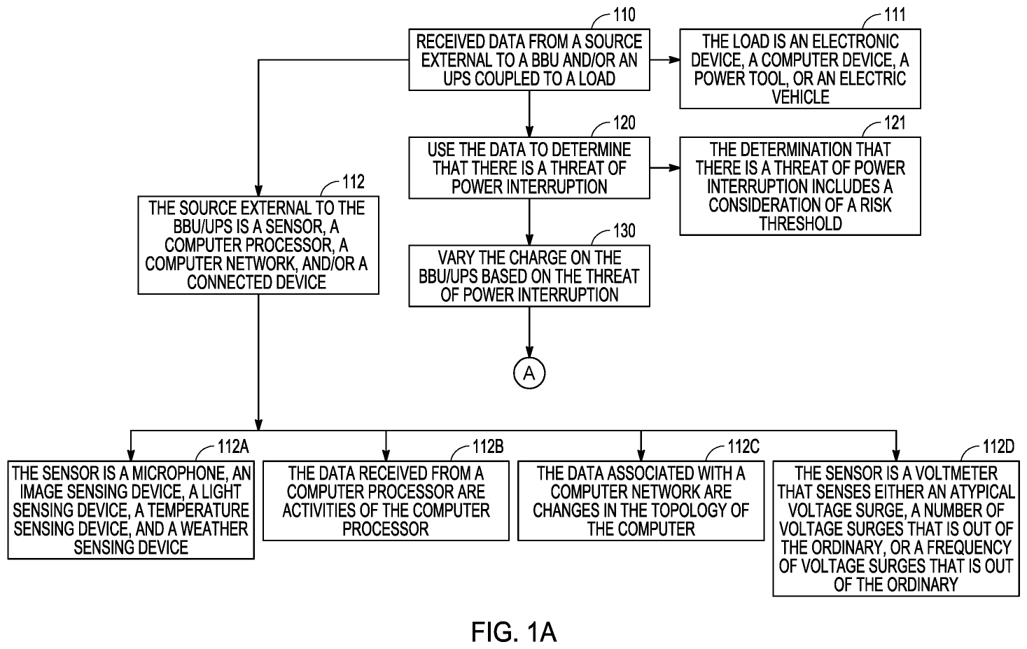

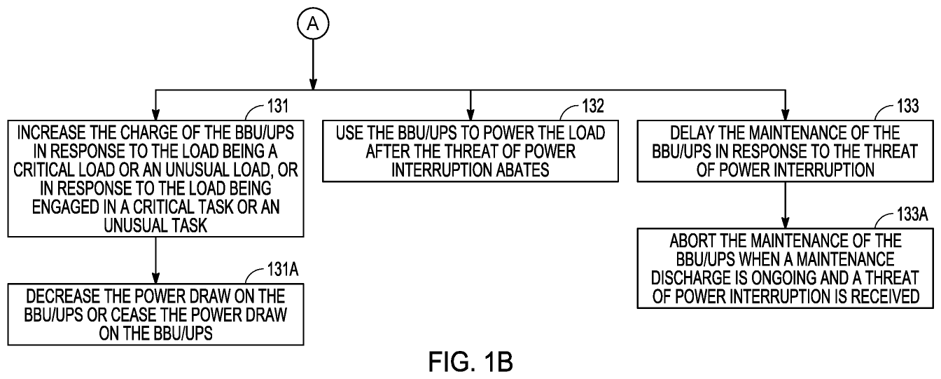

FIGS. 1A and 1B illustrate a process to improve the preparedness of backup power sources based on a threat of power interruption. FIGS. 1A and 1B include process, operation, and/or feature blocks 110-133A. Though arranged substantially serially in the example of FIG. 1, other examples may reorder the blocks, omit one or more blocks, and/or execute two or more blocks in parallel using multiple processors or a single processor organized as two or more virtual machines or sub-processors. Moreover, still other examples can implement the blocks as one or more specific interconnected hardware or integrated circuit modules with related control and data signals communicated between and through the modules. Thus, any process flow is applicable to software, firmware, hardware, and hybrid implementations.

Referring now specifically to FIGS. 1A and 1B, at 110, data are received from a source external to a battery backup unit (BBU) and/or an uninterruptable power supply (UPS) that are coupled to a load. For example, the load could be an electronic device such as a household appliance, a computer device, a power tool, or even an electric vehicle (111). The source external to the BBU/UPS can be a sensor such as a temperature or light sensor, a computer processor such as one associated with a weather database, a computer network such as the Internet, and/or a connected device such as an unrelated server on the same network (112). The sensor can be, for example, a microphone, an image sensing device, a light sensing device, a temperature sensing device, and a weather sensing device (112A). The data received from a computer processor can be, for example, an activity of the computer processor (112B). For example, an increased activity of a computer processor that is associated with a weather system could indicate impending severe weather. The data associated with a computer network could be, for example, a change in the topology of the computer network (112C). For example, if a good portion of the nodes of a network have gone down, this could indicate a loss of power to that portion of the network, and further indicate an increased threat of power interruption elsewhere. In yet another embodiment, the sensor could be a voltmeter that senses either an atypical voltage surge, several voltage surges that are out of the ordinary, and/or a frequency of voltage surges that is out of the ordinary (112D). Any of these voltage incidents could be a warning of an impending power interruption.

At 120, the data are used to determine that there is a threat of power interruption. As noted above, this threat of power interruption could be because of impending severe weather. As indicated at 121, the determination that there is a threat of power interruption includes a consideration of a risk threshold. For example, if the data indicate that the chances of a power interruption are about 40%, this may be an acceptable risk and the BBU and/or UPS will not be charged to a higher level. However, if the data indicate that the chances of a power interruption are 70%, this risk may be too high, and the BBU and/or UPS will be charged to a higher level. When this threat of power interruption is detected, then at 130, the charge on the BBU and/or the UPS is varied based on this threat of power interruption.

The varying of the charge on the BBU and/or the UPS can be either a charging of the BBU and/or UPS or a discharging of the BBU and/or UPS. For example, as indicated at 131, the charge of the BBU and/or UPS can be increased in response to the load being a critical load or an unusual load, or in response to the load being engaged in a critical task or an unusual task. For example, the load may be a refrigeration system for a grocery store, and it is critical to keep the food products properly refrigerated. Similarly, the size of the load could be more than usual, indicating that an important activity or job is being undertaken, and one that should not be adversely affected by a power outage. Furthermore, as indicated at 131A, in addition to varying the charge by increasing the charge of the BBU and/or UPS, the power draw on the BBU and/or UPS can be decreased, or the power draw on the BBU and/or UPS can be ceased altogether.

As noted, when there is a threat of a power interruption, the charge on the BBU and/or UPS can be increased up to 100%, so that if a power interruption does materialize, the BBU and/or UPS are at their maximum capacity. However, if the power interruption does not materialize, then as indicated at 132, the BBU and/or UPS can be used to power the load after the threat of power interruption abates, thereby decreasing the charge of the BBU and/or UPS. As noted above, it is beneficial to the life of the BBU and/or UPS to keep the BBU and/or UPS charged to less than 100% of total charge.

Another benefit of an embodiment involves the maintenance of the BBU and/or UPS. As noted above, part of the maintenance of a BBU and/or UPS involves completely discharging the BBU and/or UPS from time to time. As indicated at 133, such maintenance of the BBU and/or UPS can be delayed in response to the threat of power interruption. In this manner, if there is a power interruption, the BBU and/or UPS will not be discharged from the maintenance when it is needed. Similarly, as indicated at 133A, if a maintenance discharge is ongoing when the threat of power interruption is received, the maintenance of the BBU and/or UPS can be aborted in response to the threat of power interruption so that the BBU and/or UPS are not further discharged if the power interruption materializes and the BBU and/or UPS are needed.

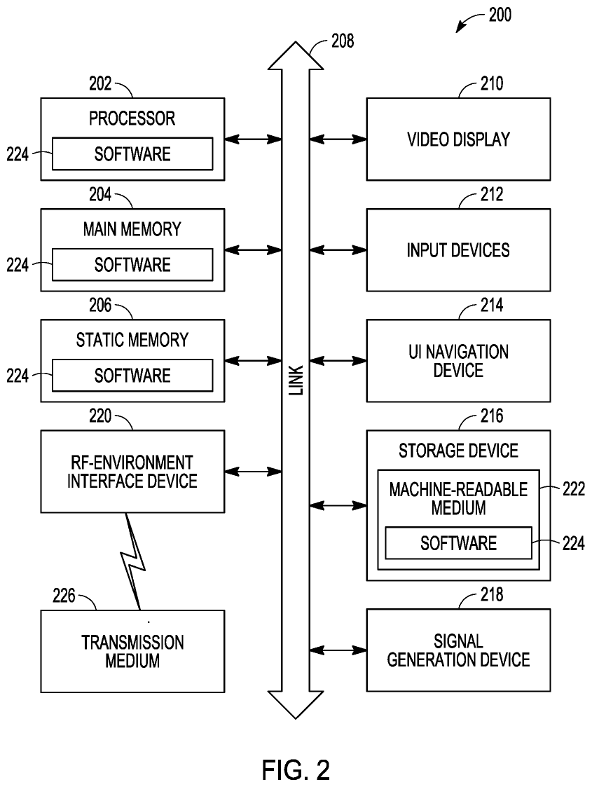

FIG. 2 is a block diagram illustrating a computing and communications platform 200 in the example form of a general-purpose machine on which some or all the operations of FIGS. 1A and 1B may be carried out according to various embodiments. In certain embodiments, programming of the computing platform 200 according to one or more particular algorithms produces a special-purpose machine upon execution of that programming. In a networked deployment, the computing platform 200 may operate in the capacity of either a server or a client machine in server-client network environments, or it may act as a peer machine in peer-to-peer (or distributed) network environments.

Example computing platform 200 includes at least one processor 202 (e.g., a central processing unit (CPU), a graphics processing unit (GPU) or both, processor cores, compute nodes, etc.), a main memory 204 and a static memory 206, which communicate with each other via a link 208 (e.g., bus). The computing platform 200 may further include a video display unit 210, input devices 212 (e.g., a keyboard, camera, microphone), and a user interface (UI) navigation device 214 (e.g., mouse, touchscreen). The computing platform 200 may additionally include a storage device 216 (e.g., a drive unit), a signal generation device 218 (e.g., a speaker), and a RF-environment interface device (RFEID) 220.

The storage device 216 includes a non-transitory machine-readable medium 222 on which is stored one or more sets of data structures and instructions 224 (e.g., software) embodying or utilized by any one or more of the methodologies or functions described herein. The instructions 224 may also reside, completely or at least partially, within the main memory 204, static memory 206, and/or within the processor 202 during execution thereof by the computing platform 200, with the main memory 204, static memory 206, and the processor 202 also constituting machine-readable media.

While the machine-readable medium 222 is illustrated in an example embodiment to be a single medium, the term “machine-readable medium” may include a single medium or multiple media (e.g., a centralized or distributed database, and/or associated caches and servers) that store the one or more instructions 224. The term “machine-readable medium” shall also be taken to include any tangible medium that is capable of storing, encoding or carrying instructions for execution by the machine and that cause the machine to perform any one or more of the methodologies of the present disclosure or that is capable of storing, encoding or carrying data structures utilized by or associated with such instructions. The term “machine-readable medium” shall accordingly be taken to include, but not be limited to, solid-state memories, and optical and magnetic media. Specific examples of machine-readable media include non-volatile memory, including but not limited to, by way of example, semiconductor memory devices (e.g., electrically programmable read-only memory (EPROM), electrically erasable programmable read-only memory (EEPROM)) and flash memory devices; magnetic disks such as internal hard disks and removable disks; magneto-optical disks; and CD-ROM and DVD-ROM disks.

RFEID 220 includes radio receiver circuitry, along with analog-to-digital conversion circuitry, and interface circuitry to communicate via link 208 according to various embodiments. Various form factors are contemplated for RFEID 220. For instance, RFEID may be in the form of a wideband radio receiver, or scanning radio receiver, that interfaces with processor 202 via link 208. In one example, link 208 includes a PCI Express (PCIe) bus, including a slot into which the NIC form-factor may removably engage. In another embodiment, RFEID 220 includes circuitry laid out on a motherboard together with local link circuitry, processor interface circuitry, other input/output circuitry, memory circuitry, storage device and peripheral controller circuitry, and the like. In another embodiment, RFEID 220 is a peripheral that interfaces with link 208 via a peripheral input/output port such as a universal serial bus (USB) port. RFEID 220 receives RF emissions over wireless transmission medium 226. RFEID 220 may be constructed to receive RADAR signaling, radio communications signaling, unintentional emissions, or some combination of such emissions.

The above detailed description includes references to the accompanying drawings, which form a part of the detailed description. The drawings show, by way of illustration, specific embodiments that may be practiced. These embodiments are also referred to herein as “examples.” Such examples may include elements in addition to those shown or described. However, also contemplated are examples that include the elements shown or described. Moreover, also contemplated are examples using any combination or permutation of those elements shown or described (or one or more aspects thereof), either with respect to a particular example (or one or more aspects thereof), or with respect to other examples (or one or more aspects thereof) shown or described herein.

Publications, patents, and patent documents referred to in this document are incorporated by reference herein in their entirety, as though individually incorporated by reference. In the event of inconsistent usages between this document and those documents so incorporated by reference, the usage in the incorporated reference(s) are supplementary to that of this document; for irreconcilable inconsistencies, the usage in this document controls.

In this document, the terms “a” or “an” are used, as is common in patent documents, to include one or more than one, independent of any other instances or usages of “at least one” or “one or more.” In this document, the term “or” is used to refer to a nonexclusive or, such that “A or B” includes “A but not B,” “B but not A,” and “A and B,” unless otherwise indicated. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to suggest a numerical order for their objects.

The above description is intended to be illustrative, and not restrictive. For example, the above-described examples (or one or more aspects thereof) may be used in combination with others. Other embodiments may be used, such as by one of ordinary skill in the art upon reviewing the above description. The Abstract is to allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. However, the claims may not set forth every feature disclosed herein as embodiments may feature a subset of said features. Further, embodiments may include fewer features than those disclosed in a particular example. Thus, the following claims are hereby incorporated into the Detailed Description, with a claim standing on its own as a separate embodiment. The scope of the embodiments disclosed herein is to be determined with reference to the appended claims, along with the full scope of equivalents to which such claims are entitled.

1. A process comprising:
receiving data from a source external to a battery backup unit (BBU) or an uninterruptable power supply (UPS), the BBU or the UPS configured for coupling to a load;
determining from the data that there is a threat of power interruption;
varying a charge on the BBU or the UPS based on the threat of power interruption; and
using the BBU or the UPS to power the load after the threat of power interruption abates, thereby decreasing the charge of the BBU or UPS.

2. The process of claim 1, wherein the source external to the BBU or the UPS comprises one or more of a sensor, a computer processor, a computer network, and a connected device.

3. The process of claim 2, wherein the sensor comprises one or more of a microphone, an image sensing device, a light sensing device, a temperature sensing device; and a weather sensing device.

4. The process of claim 2, wherein the data from the computer processor relates to an activity of the computer processor, and the data from the computer network relates to a change to a topology of the computer network.

5. The process of claim 2, wherein the sensor senses an atypical voltage surge, a greater number of voltage surges, or a greater frequency of voltage surges.

6. The process of claim 1, comprising increasing the charge of the BBU or the UPS in response to the load being a critical load or an unusual load, or in response to the load being engaged in a critical task or an unusual task.

7. (canceled)

8. The process of claim 1, comprising delaying maintenance of the BBU or the in response to the threat of power interruption.

9. The process of claim 8, wherein maintenance of the BBU or the UPS includes a discharging of the BBU or UPS.

10. The process of claim 1, comprising aborting maintenance of the BBU or the UPS in response to the threat of power interruption.

11. The process of claim 1, wherein the load comprises one or more of an electronic device, a computer device, a power tool, or an electric vehicle.

12. The process of claim 1, wherein the BBU or the UPS is coupled to the load.

13. The process of claim 1, wherein varying the charge comprises increasing the charge of the BBU or the UPS, decreasing a power draw on the BBU or the UPS, or ceasing the power draw on the BBU or the UPS.

14. The process of claim 1, wherein the determining from the data that there is a threat of power interruption comprises a consideration of a risk threshold.

15. A non-transitory machine-readable medium comprising instructions that when executed by a processor execute a process comprising:
receiving data from a source external to a battery backup unit (BBU) or an uninterruptable power supply (UPS), the BBU or the UPS configured for coupling to a load;
determining from the data that there is a threat of power interruption;
varying a charge on the BBU or the UPS based on the threat of power interruption; and
using the BBU or the UPS to power the load after the threat of power interruption abates thereby decreasing the charge of the BBU or UPS.

16. The non-transitory machine-readable medium of claim 15, wherein the source external to the BBU or the UPS comprises one or more of a sensor, a computer processor, a computer network, and a connected device; wherein the sensor comprises one or more of a microphone, an image sensing device, a light sensing device, a temperature sensing device, and a weather sensing device; wherein the computer processor comprises an activity of the computer processor and the computer network comprises a change to a topology of the computer network; and wherein the sensor senses an atypical voltage surge, a greater number of voltage surges, or a greater frequency of voltage surges.

17. The non-transitory machine-readable medium of claim 15, comprising instructions for increasing the charge of the BBU or the UPS in response to the load being a critical load or an unusual load or in response to the load being engaged in a critical task or an unusual task.

18. (canceled)

19. The non-transitory machine-readable medium of claim 15, comprising instructions for delaying maintenance of the BBU or the UPS in response to the threat of power interruption; wherein maintenance of the BBU or the UPS includes a discharging of the BBU or UPS; and for aborting maintenance of the BBU or the UPS in response to the threat of power interruption.

20. The non-transitory machine-readable medium of claim 15, wherein varying the charge comprises increasing the charge of the BBU or the UPS, decreasing a power draw on the BBU or the UPS, or ceasing the power draw on the BBU or the UPS.
